(19) United States
(12) Patent Application Publication
(10) Pub. No.: US 2024/0308594 A1
(43) Pub. Date: Sep. 19, 2024

(54) VEHICLE BODY FRONT PART STRUCTURE

(71) Applicant: SUBARU CORPORATION, Tokyo (JP)

(72) Inventor: Isamu NAGASAWA, Tokyo (JP)

(21) Appl. No.: 18/600,173

(22) Filed: Mar. 8, 2024

(30) Foreign Application Priority Data
Mar. 17, 2023 (JP) 2023-043378

(51) Int. Cl. B62D 25/08

(52) U.S. Cl. CPC B62D 25/085; B62D 25/084

(57) ABSTRACT

A vehicle body front part structure includes a radiator panel frame, front side frames in a pair, sub frames, upper frame reinforcing members in a pair, radiator panel reinforcing members, and joint members. The radiator panel frame includes projections protruding toward the vehicle rear side. The front side frames are joined to the radiator panel frame at front ends. The sub frames are joined to the radiator panel frame at front ends. The upper frame reinforcing members are bent downward toward the vehicle front side to have slope parts and are joined to the radiator panel frame at lower front ends. The radiator panel reinforcing members respectively have first ends joined to an upper side member of the radiator panel frame and second ends joined to upper front sides of the slope parts. The joint members respectively join the upper frame reinforcing members and the front side frames.

### CROSS-REFERENCE TO RELATED APPLICATIONS

The present application claims priority from Japanese Patent Application No. 2023-043378 filed on Mar. 17, 2023, the entire contents of which are hereby incorporated by reference.

### BACKGROUND

The disclosure relates to a vehicle body front part structure.

Typically, in a frontal collision of a vehicle, preventing deformation of a cabin, which is an occupant boarding space, is an effective way to reduce injury to an occupant, and various measures are taken for this purpose. In recent years, a structure for absorbing collision energy in front of the cabin has been widely used.

When considering frontal collisions of vehicles, multiple types of collision, such as a full-overlap collision in which the whole surface of a vehicle in the vehicle traveling direction collides with an object, an offset collision in which one side of a vehicle in the vehicle traveling direction collides with an object, and an under-ride collision in which the upper side of a vehicle in the vehicle traveling direction collides with an object are taken into consideration.

In a vehicle such as a hybrid vehicle or an electric vehicle, an inverter unit for converting a DC voltage into an AC voltage to drive an electric motor may be mounted in the front of the vehicle.

The inverter unit generates a high voltage necessary for traveling of the vehicle. Hence, if the inverter unit is deformed or disconnected due to a frontal collision or the like of the vehicle, a sudden abnormal reaction may occur.

Hence, there has been a demand for a vehicle body front part structure that absorbs collision energy to prevent damage to the inverter unit in any collision type.

In response to this demand, Japanese Unexamined Patent Application Publication (JP-A) No. 2006-290224 has proposed a structure in which each of ends of a front bumper reinforcement in the longitudinal direction thereof is coupled to an upper member, a radiator support upper, a front side member, and a radiator support lower via a coupling body including first to fourth coupling members formed as a single component. In a small-overlap collision, in which an object collides with an end of the front bumper reinforcement in the longitudinal direction thereof, this structure supports the end, transmits a collision load to a body side, and absorbs the energy.

### SUMMARY

An aspect of the disclosure provides a vehicle body front part structure provided in a front portion of a vehicle in a vehicle longitudinal direction of the vehicle. The front portion is provided in front of a cabin configured to accommodate one or more occupants of the vehicle. The vehicle body front part structure includes: a radiator panel frame provided in the front portion, the radiator panel frame having a rectangular shape having long sides extending in a vehicle width direction of the vehicle and short sides extending in a vehicle vertical direction of the vehicle, and comprising projections on outer sides of an upper side member in the vehicle width direction, the projections protruding toward a rear side of the vehicle; front side frames in a pair, the front side frames being disposed respectively on both sides in the vehicle width direction on a lower side of the vehicle, extending in the vehicle longitudinal direction of the vehicle, and having front ends joined to the radiator panel frame in the front portion; sub frames disposed below and on outer sides of the front side frames in the vehicle width direction, extending in the vehicle longitudinal direction, and having front ends on the front side of the vehicle joined to lower outer parts of the radiator panel frame in the vehicle width direction; upper frame reinforcing members in a pair, the upper frame reinforcing members being disposed respectively on both sides in the vehicle width direction on an upper side of the vehicle, extending forward from the front portion, being bent downward toward the front side of the vehicle to have slope parts extending toward a lower front side of the vehicle in the front portion, and having lower front ends on the lower side of the vehicle joined to respective lower outer parts of the radiator panel frame in the vehicle width direction; radiator panel reinforcing members each having a first end joined to the upper side member of the radiator panel frame at a position more inward than a corresponding one of the projection in the vehicle width direction, and a second end joined to an upper front side of a corresponding one of the slope parts; and joint members each joining a corresponding one of the upper frame reinforcing members and a corresponding one of the front side frames at a corresponding one of the slope parts.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a perspective view of a vehicle body front part structure according to an embodiment of the disclosure as viewed from above;

FIGS. 2A to 2C are schematic views of the vehicle body front part structure illustrated in FIG. 1 without front wheels and strut towers, in which FIG. 2A is a plan view as viewed from above the vehicle, FIG. 2B is a side view, and FIG. 2C is a front view as viewed from the vehicle traveling direction;

FIGS. 3A to 3C are schematic views of an object to collide with the front side of the vehicle body front part structure, as viewed from the front side of the vehicle, in which FIG. 3A illustrates the object at the time of a full-overlap collision, FIG. 3B illustrates the object at the time of a small-overlap collision, and FIG. 3C illustrates the object at the time of an under-ride collision;

FIG. 4 is a perspective view, as viewed from above, illustrating deformation of the vehicle body front part structure according to the embodiment of the disclosure at the time of a full-overlap collision;

FIG. 5 is a perspective view, as viewed from above, illustrating deformation of the vehicle body front part structure according to the embodiment of the disclosure at the time of a small-overlap collision; and

FIG. 6 is a perspective view, as viewed from above, illustrating deformation of the vehicle body front part structure according to the embodiment of the disclosure at the time of an under-ride collision.

### DETAILED DESCRIPTION

The technique disclosed in JP-A No. 2006-290224 does not consider a full-overlap collision or an under-ride collision, and thus, there is a problem in that the inverter unit may be deformed when a full-overlap collision or an under-ride collision occurs at the front side of the vehicle.

It is desirable to provide a vehicle body front part structure that prevents deformation of the inverter unit in multiple types of frontal collision.

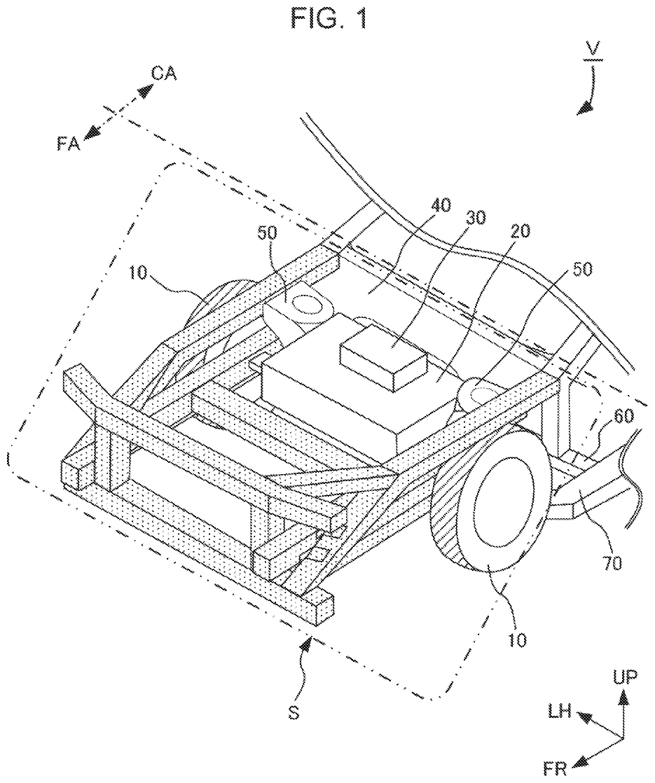

A vehicle V having a vehicle body front part structure S (hereinbelow, a front part structure S) according to an embodiment of the disclosure will be described with reference to FIGS. 1 to 6. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description. Note that arrows FR, UP, and LH in the drawings indicate the traveling direction of the vehicle V illustrated in FIG. 1, the upper side of the vehicle V, and the left side of the vehicle V as viewed from the vehicle traveling direction, respectively. In the following description, unless otherwise specified, a vertical (top-bottom) direction and a lateral (left-right) direction are directions as viewed from the vehicle traveling direction, and a longitudinal (front-rear) direction is a direction in which the vehicle traveling direction is the front side.

### Embodiment

The structure of the front part structure S according to this embodiment, provided in the vehicle V, will be described with reference to FIGS. 1 to 6.

The description is based on an assumption that the vehicle V is an electric vehicle (EV) or a hybrid electric vehicle (HEV).

### Structure of Vehicle V

The vehicle Vis, for example, an electric vehicle having a power unit 20, serving as a drive source. The vehicle V may be, for example, a hybrid electric vehicle having multiple drive sources including an engine and the power unit 20.

In the vehicle V, a vehicle front chamber FA (hereinbelow, a front chamber FA) is provided in front of a cabin CA, serving as a compartment for occupants.

As illustrated in FIG. 1, the front chamber FA includes front wheels 10, the power unit 20, an inverter unit 30, a toe board 40, strut towers 50, a torque box 60, side sills 70, and the front part structure S (a dot-hatched part surrounded by a two-dot chain line in FIG. 1).

The power unit 20 is a drive device including a vehicle driving motor (not illustrated) for driving the front wheels 10, a transmission, a clutch, and a drive shaft. The power unit 20 is installed in a space surrounded by front side frames 110 (described below), a front cross member 130 (described below), the toe board 40, and the torque box 60, and is fixed in a state of being disposed on the upper surfaces of the front side frames 110.

The inverter unit 30 is disposed on and fixed to the upper side of the power unit 20. The inverter unit 30 generates a voltage to be supplied to the vehicle driving motor.

The inverter unit 30 is capable of outputting a high voltage to be supplied to the power unit 20 and generates a voltage necessary for driving the power unit 20.

The power unit 20 and the inverter unit 30 are installed in a space surrounded by a robust frame.

The front part structure S is provided in front of the power unit 20 and the inverter unit 30, and the power unit 20 and the inverter unit 30 are provided between the strut towers 50 in the vehicle width direction. The toe board 40, the torque box 60, and the side sills 70 are provided behind the power unit 20 and the inverter unit 30.

The toe board 40 is provided in front of the cabin CA so as to stand upright in the vehicle vertical direction to divide between the front chamber FA and the cabin CA. The toe board 40 is joined to the upper side of the torque box 60 and to the rear ends of the front side frames 110 by welding or the like.

The strut towers 50 are supports on the vehicle body side to which suspensions are attached, and are provided on both sides in the vehicle width direction, in front of the toe board 40. The strut towers 50 are frameworks inclined inward in the vehicle width direction from the upper side to the lower side thereof, and are formed of, for example, high rigidity metal.

The strut towers 50 are joined to upper frame reinforcing members 140 (described below) at the upper outer sides thereof, and are joined to the front side frames 110 and sub frames 120 at the lower inner sides thereof.

The torque box 60 is a member disposed between the sub frames 120 (described below) and the side sills 70 to couple the sub frames 120 and the side sills 70 to each other.

The torque box 60 is a framework extending in the vehicle width direction at the bottom of the vehicle V, and the right and left front side frames 110 are joined, at one end thereof, to the torque box 60 by welding or the like. The torque box 60 is formed of, for example, high rigidity metal, and has a closed substantially rectangular cross-section.

The side sills 70 are provided at side bottom surfaces of the vehicle, on both sides in the vehicle width direction, behind the toe board 40. The side sills 70 are frameworks extending in the vehicle longitudinal direction, are formed of, for example, high rigidity metal, and have a closed substantially rectangular cross-section.

The front part structure S is provided inside the front chamber FA in front of the toe board 40.

Hereinbelow, the structure of the front part structure S will be described.

### Structure of Front Part Structure S

The front part structure S is bilaterally symmetrical in the vehicle width direction.

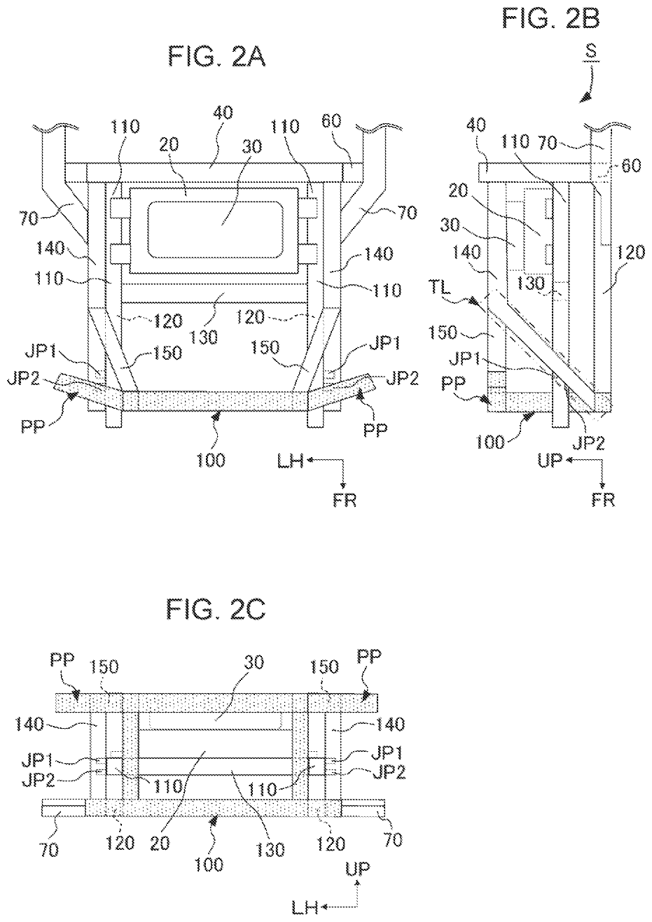

As illustrated in FIGS. 2A to 2C, the front part structure S includes a radiator panel frame 100, the front side frames 110, the sub frames 120, the front cross member 130, the upper frame reinforcing members 140, and the radiator panel reinforcing members 150.

### Radiator Panel Frame 100

As indicated by dot hatching in FIGS. 2A to 2C, the radiator panel frame 100 is a framework extending in the vehicle width direction and the vehicle vertical direction at the front side of the vehicle V.

As illustrated in FIG. 2C, the radiator panel frame 100 is formed by joining frames, which are formed of, for example, metal and have a closed substantially rectangular cross-section, in a substantially rectangular shape as viewed from the vehicle traveling direction, such that the long sides extend in the vehicle width direction and the short sides extend in the vehicle vertical direction.

The ends of the lower side member of the radiator panel frame 100 protrude outward in the vehicle width direction from the short sides of the radiator panel frame 100. The upper frame reinforcing members 140 are joined to the protruding ends of the lower side member by welding or the like. The sub frames 120 are joined by welding or the like to a rear surface of the lower side member, at positions on the more inner side than the upper frame reinforcing members 140.

Furthermore, projections PP protruding toward the rear side of the vehicle are formed at the ends of the upper side member of the radiator panel frame 100, on the outer sides of the upper side member of the radiator panel frame 100 in the vehicle width direction. The projections PP are formed of, for example, metal and have a rigid, closed substantially rectangular cross-section.

### Front Side Frames 110

As illustrated in FIG. 2A, the front side frames 110 are provided in a pair and extend in the vehicle longitudinal direction on both sides of the power unit 20 in the vehicle width direction, below the power unit 20.

The front ends of the front side frames 110 are joined by welding or the like to the outside parts of the radiator panel frame 100 in the vehicle width direction. The front side frames 110 protrude forward beyond the radiator panel frame 100. The rear ends of the front side frames 110 are joined to the toe board 40 by welding or the like.

As illustrated in FIG. 2B, at positions in front of the positions where the front side frames 110 and the upper frame reinforcing members 140 cross each other, the upper parts of the upper frame reinforcing members 140 and the outside parts of the front side frames 110 in the vehicle width direction are joined to each other with joint members JP.

The front side frames 110 are formed of, for example, high rigidity metal and have a closed substantially rectangular cross-section.

### Sub Frames 120

As illustrated in FIG. 2B, the sub frames 120 are provided in a pair and extend in the vehicle longitudinal direction on both sides in the vehicle width direction, below and on the outer sides of the front side frames 110 in the vehicle width direction. The sub frames 120 are joined to the lower outer parts, in the vehicle width direction, of the radiator panel frame 100 at the front ends thereof. The rear ends of the sub frames 120 are joined to the torque box 60 and the side sills 70 by welding or the like.

The sub frames 120 are formed of, for example, high rigidity metal and have a closed substantially rectangular cross-section.

### Front Cross Member 130

As illustrated in FIG. 2A, the front cross member 130 extends in the vehicle width direction in front of the inverter unit 30 and is joined by welding or the like to the front side frames 110 at the ends thereof in the vehicle width direction.

The front cross member 130 is formed of, for example, metal and has a closed substantially rectangular cross-section.

### Upper Frame Reinforcing Members 140

The upper frame reinforcing members 140 extend in the vehicle longitudinal direction, on both sides in the vehicle width direction, on the upper side of the vehicle, from the upper part of the toe board 40 in front of the cabin CA.

As illustrated in FIG. 2B, the upper frame reinforcing members 140 are bent in front of the front cross member 130 to form slope parts TL extending toward the lower front side of the vehicle.

The front sides of the slope parts TL of the upper frame reinforcing members 140 and the outer sides of the front side frames 110 in the vehicle width direction are fixed to each other with the joint members JP, at positions behind the radiator panel frame 100 and in front of the positions where the upper frame reinforcing members 140 and the front side frames 110 cross each other.

The lower front ends of the upper frame reinforcing members 140 are joined by welding or the like to the upper surfaces of the ends of the lower side member of the radiator panel frame 100 protruding outward in the vehicle width direction.

The rear ends of the upper frame reinforcing members 140 are joined to the upper parts of the toe board 40 and the strut towers 50 by welding or the like.

The upper frame reinforcing members 140 are formed of, for example, metal and have a closed substantially rectangular cross-section.

### Joint Member JP

As illustrated in FIG. 2B, the joint members JP (JP1 and JP2) fix the upper frame reinforcing members 140 and the front side frames 110 to each other at the slope parts TL of the upper frame reinforcing members 140.

The joint members JP are formed of, for example, L-shaped plates bent so as to extend forward in the vehicle longitudinal direction and outward in the vehicle width direction. The joint members JP are flat plates made of metal or the like and bent so as to make contact with the front sides of the slope parts TL of the upper frame reinforcing members 140 and the outer surfaces of the front side frames 110 in the vehicle width direction.

The joint members JP have, for example, bolt holes penetrating in the plate thickness direction in the surfaces to make contact with the front side frames 110 and the upper frame reinforcing members 140.

The joint members JP are fixed to upper ridges and lower ridges of the outer surfaces of the front side frames 110 in the vehicle width direction, at positions where the front side frames 110 and the upper frame reinforcing members 140 cross each other. The joint members JP1 are fixed to the upper ridges of the front side frames 110 with bolts or the like, and the joint members JP2 are fixed to the lower ridges of the front side frames 110 with bolts or the like.

### Radiator Panel Reinforcing Members 150

The radiator panel reinforcing members 150 extend in the vehicle longitudinal direction from the upper outer sides of the radiator panel frame 100 in the vehicle width direction.

The front ends, or first ends, of the radiator panel reinforcing members 150 are joined by welding or the like to the rear surface of the upper side member of the radiator panel frame 100, at positions more inward than the projections PP in the vehicle width direction, and the rear ends, or second ends, of the radiator panel reinforcing members 150 are joined by welding or the like to the upper front sides of the slope parts TL of the upper frame reinforcing members 140.

As illustrated in FIG. 2A, the radiator panel reinforcing members 150 are disposed such that the distance therebetween increases from the front side toward the rear side of the vehicle.

The radiator panel reinforcing members 150 are formed of, for example, metal and have a closed substantially rectangular cross-section.

The front part structure S is a robust three-dimensional framework formed by joining together the radiator panel frame 100, the front side frames 110, the sub frames 120, the front cross member 130, the upper frame reinforcing members 140, and the radiator panel reinforcing members 150.

Furthermore, the front part structure S, the toe board 40, the strut towers 50, the torque box 60, and the side sills 70 are joined together to form the robust front chamber FA.

### Operation

The operation of the thus-configured front part structure S according to this embodiment when an object collides with the vehicle V from the vehicle traveling direction will be described.

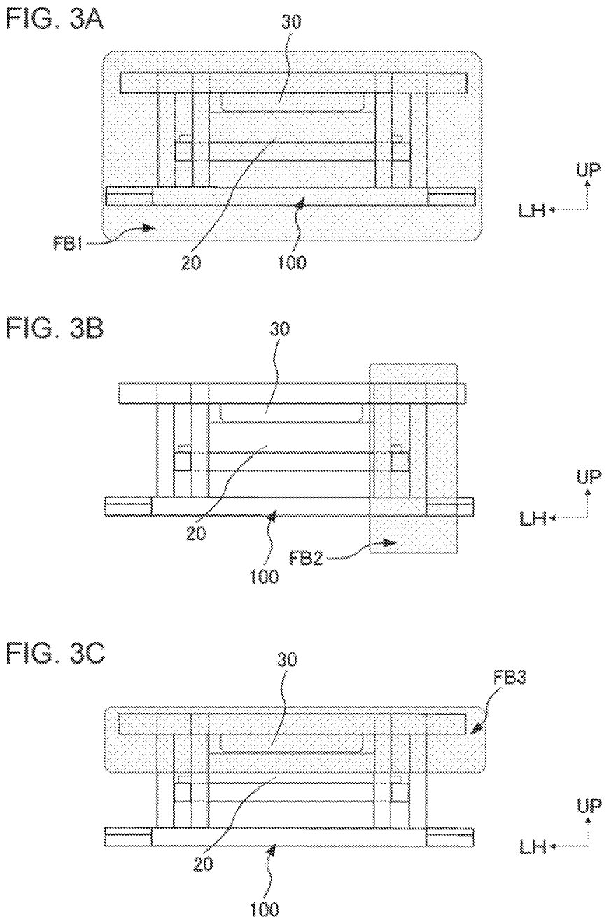

As illustrated by hatching in FIG. 3A, in a full-overlap collision in which an object FB1 collides with the vehicle V from the vehicle traveling direction, the object FB1 collides with the front side of the vehicle V.

As illustrated by hatching in FIG. 3B, in a small-overlap collision in which an object FB2 collides with the vehicle V from the vehicle traveling direction, the object FB2 collides with the right or left outer side, in the vehicle width direction, of the front part of the vehicle V.

As illustrated by hatching in FIG. 3C, in an under-ride collision in which an object FB3 collides with the vehicle V from the vehicle traveling direction, the object FB3 collides with the upper side of the vehicle V.

### Full-Overlap Collision

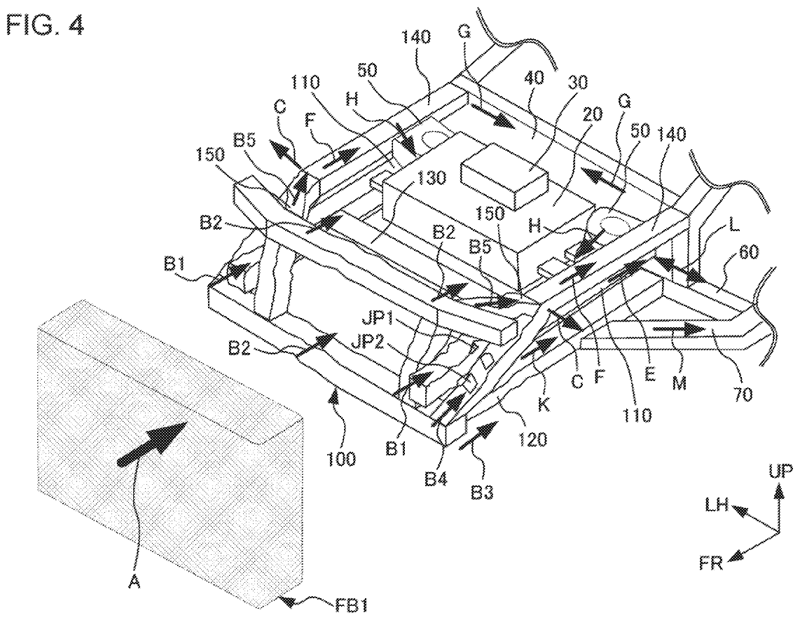

As illustrated in FIG. 4, in a full-overlap collision in which the object FB1 collides with the vehicle V from the vehicle traveling direction, the object FB1 collides with the front side of the vehicle V, generating collision energy in the direction of arrow A.

The collision energy generated by the collision with the object FB1 is transmitted to the rear side of the vehicle via the radiator panel frame 100, the front side frames 110, the sub frames 120, the upper frame reinforcing members 140, and the radiator panel reinforcing members 150, as indicated by arrows B1 to B5.

The collision energy indicated by arrows B1, directed from the front side to the rear side of the vehicle, is transmitted to the front side frames 110. The front ends of the front side frames 110 are crushed by the collision energy, and the collision energy is absorbed by the deformation of the front ends of the front side frames 110.

Furthermore, the collision energy transmitted to the front side frames 110, indicated by arrow E, is distributed to and absorbed by the toe board 40, which is joined to the rear side of the front side frames 110, as indicated by arrows G.

In a full-overlap collision, the collision energy moves the front side frames 110 from the front side toward the rear side of the vehicle, shifting the relative positions of the front side frames 110 and the upper frame reinforcing members 140.

At the upper ridges and the lower ridges of the front side frames 110, the front side frames 110 and the slope parts TL of the upper frame reinforcing members 140 are fixed to each other with the joint members JP (joint members JP1 and JP2). The joint members JP are formed of L-shaped plates bent so as to extend forward in the vehicle longitudinal direction and outward in the vehicle width direction.

Hence, when the relative positions of the front side frames 110 and the upper frame reinforcing members 140 are shifted, the joint members JP1 and JP2 start to break along the bent portions thereof.

As a result of the joint members JP1 and JP2 being broken and the front side frames 110 and the upper frame reinforcing members 140 being separated from each other, the front side frames 110 become free from the influence of the rigidity of the upper frame reinforcing members 140. As a result of the front side frames 110 being crushed and deformed in front of the front cross member 130, the collision energy is absorbed.

As the crushing of the front ends of the front side frames 110 and the deformation of the front side frames 110 toward the rear side of the vehicle progress, the collision energy indicated by arrows B2, directed from the front side to the rear side of the vehicle, is transmitted to the radiator panel frame 100 connected to the front side frames 110. Then, as a result of the radiator panel frame 100 being pushed by the collision energy indicated by arrows B2, the collision energy indicated by arrows B3 to B5, directed to the rear side of the vehicle, is transmitted to the sub frames 120, the upper frame reinforcing members 140, and the radiator panel reinforcing members 150.

The collision energy indicated by arrow B3, directed from the front side to the rear side of the vehicle, is transmitted to the sub frames 120 via the radiator panel frame 100. The front ends of the sub frames 120 are crushed by the collision energy, and the collision energy is absorbed by the crushing and deformation of the sub frames 120.

Furthermore, the collision energy transmitted to the sub frames 120, indicated by arrow K, is distributed among and absorbed by the toe board 40, the torque box 60, and the side sills 70, which are joined to the rear side of the sub frames 120, as indicated by arrows G, L, and M, respectively.

The collision energy indicated by arrow B4, directed from the front side to the rear side of the vehicle, is transmitted to the upper frame reinforcing members 140 via the radiator panel frame 100. Furthermore, the collision energy indicated by arrows B4 and B5 is transmitted to the joint parts between the upper parts of the slope parts TL and the radiator panel reinforcing members 150.

The collision energy transmitted to the upper frame reinforcing members 140, indicated by arrows F, is distributed between and absorbed by the toe board 40 and the strut towers 50, which are joined to the rear side of the upper frame reinforcing members 140, as indicated by arrows G and H.

The collision energy indicated by arrows B5, directed from the front side to the rear side of the vehicle, is transmitted to the radiator panel reinforcing members 150 via the radiator panel frame 100. Then, the collision energy is absorbed by crushing and deformation of the radiator panel reinforcing members 150.

Because the radiator panel reinforcing members 150 are disposed such that the distance therebetween increases from the front side toward the rear side of the vehicle, the collision energy deforms the upper frame reinforcing members 140 toward the outer sides in the vehicle width direction, as indicated by arrows C.

The collision energy indicated by arrows B5, transmitted to the radiator panel reinforcing members 150, is then transmitted to the upper frame reinforcing members 140 and is distributed and absorbed via the upper frame reinforcing members 140.

Absorption of the collision energy by the deformation of the front part structure S ends with the end of input of the collision energy.

As described above, the collision energy generated by the collision with the object FB1 is absorbed by crushing and deformation of the front part structure S, which includes the radiator panel frame 100, the front side frames 110, the sub frames 120, the front cross member 130, the upper frame reinforcing members 140, and the radiator panel reinforcing members 150.

Furthermore, as a result of the joint members JP fixing the front side frames 110 and the upper frame reinforcing members 140 to each other being deformed or broken, the front side frames 110 become free from the influence of the rigidity of the upper frame reinforcing members 140. In addition, as a result of the front side frames 110 being deformed and crushed in front of the front cross member 130, the collision energy is absorbed.

The collision energy generated by the collision with the object FB1 is distributed in and absorbed by the front chamber FA, which includes the front side frames 110, the front cross member 130, the toe board 40, the strut towers 50, the torque box 60, and the side sills 70.

Hence, the inverter unit 30, which is disposed between, in the vehicle width direction, the front side frames 110, the sub frames 120, and the upper frame reinforcing members 140 extending in the vehicle longitudinal direction on both sides in the vehicle width direction and behind the front cross member 130, is not deformed.

### Small-Overlap Collision

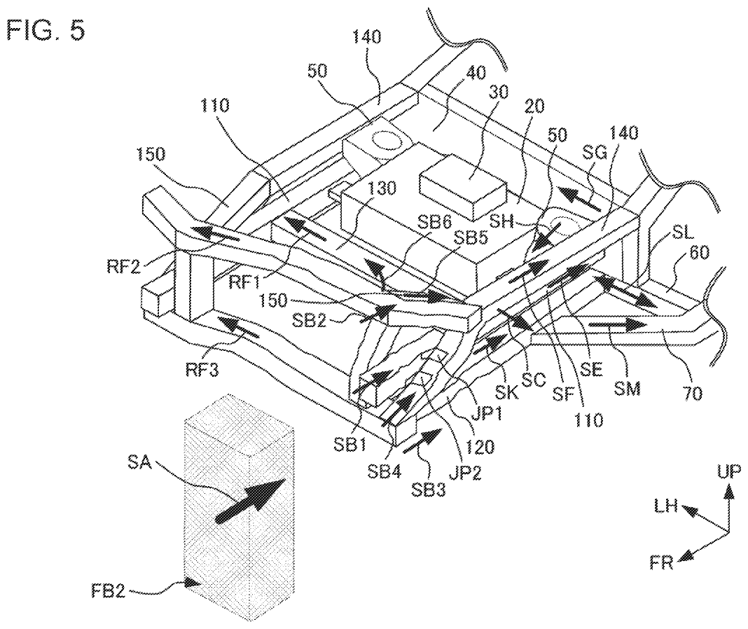

As illustrated in FIG. 5, in a small-overlap collision, the object FB2 collides with the outer right or left front side of the vehicle V, generating collision energy in the direction of arrow SA.

Hereinbelow, the case where the object FB2 collides with the right side of the vehicle V, as viewed from the vehicle traveling direction, will be described.

The collision energy generated by the collision with the object FB2 is transmitted to the rear side of the vehicle via the radiator panel frame 100, the front side frames 110, the sub frames 120, the upper frame reinforcing members 140, and the radiator panel reinforcing members 150, as indicated by arrows SB1 to SB5.

The collision energy indicated by arrow SB1, directed from the front side to the rear side of the vehicle, is transmitted to the front side frame 110. The front end of the front side frame 110 is crushed by the collision energy, and the collision energy is absorbed by the deformation of the front end of the front side frame 110.

Furthermore, the collision energy transmitted to the front side frame 110, indicated by arrow SE, is distributed to and absorbed by the toe board 40, which is joined to the rear side of the front side frame 110, as indicated by arrow SG.

As the crushing of the front end of the front side frame 110 and the deformation of the front side frame 110 toward the rear side of the vehicle progress, the collision energy indicated by arrow SB2, directed from the front side to the rear side of the vehicle, is transmitted to the radiator panel frame 100 connected to the front side frame 110. Then, as a result of the radiator panel frame 100 being pushed by the collision energy indicated by arrow SB2, the collision energy indicated by arrows SB3 to SB5, directed to the rear side of the vehicle, is transmitted to the sub frame 120, the upper frame reinforcing member 140, and the radiator panel reinforcing member 150.

At this time, reaction forces indicated by arrows RF1 to RF3 are generated from the radiator panel frame 100 and the front cross member 130 on the non-collided side. In other words, the radiator panel frame 100 and the front cross member 130 on the collided side are pulled toward the inner side in the vehicle width direction, which is the non-collided side.

The collision energy transmitted to the radiator panel frame 100 and the front cross member 130 on the collided side is cancelled by the reaction forces transmitted via the radiator panel frame 100 and the front cross member 130 and is absorbed.

Furthermore, the reaction force generated at the front cross member 130 and directed to the inner side in the vehicle width direction, as indicated by arrow RF1, generates, in the front side frame 110, rotational motion directed to the inner side in the vehicle width direction.

At this time, because the front side frame 110 moves toward the inner side in the vehicle width direction, the joint members JP keep the front side frame 110 and the upper frame reinforcing member 140 fixed to each other without being broken. Thus, the upper frame reinforcing member 140 restricts the rotational motion of the front side frame 110 via the joint members JP.

As a result of the front side frame 110 and the upper frame reinforcing member 140 fixed to each other being deformed in front of the front cross member 130 while maintaining rigidity, the collision energy is absorbed.

Due to the reaction forces in the radiator panel frame 100, indicated by arrows RF2 and RF3, the radiator panel frame 100 starts to rotate toward the inner rear side of the vehicle, as indicated by arrow SB6, about the lower side member and the non-collided side of the radiator panel frame 100. The front side frame 110, the sub frame 120, the upper frame reinforcing member 140, and the radiator panel reinforcing member 150, which are joined to the radiator panel frame 100, are deformed toward the inner side in the vehicle width direction.

When the deformation progresses in the direction indicated by arrow SB6, the projection PP protruding outward at the upper part of the radiator panel frame 100 comes into contact with the upper frame reinforcing member 140 and the radiator panel reinforcing member 150. Then, the rotational motion in the direction indicated by arrow SB6 is restricted by the upper frame reinforcing member 140 and the radiator panel reinforcing member 150.

The collision energy indicated by arrow SB3, directed from the front side to the rear side of the vehicle, is transmitted to the sub frame 120 via the radiator panel frame 100. The front end of the sub frame 120 is crushed by the collision energy, and the collision energy is absorbed by the crushing and deformation of the sub frame 120.

Furthermore, the collision energy transmitted to the sub frame 120, indicated by arrow SK, is distributed among and absorbed by the toe board 40, the torque box 60, and the side sill 70, which are joined to the rear side of the sub frame 120, as indicated by arrows SG, SL, and SM, respectively.

The collision energy indicated by arrow SB4, directed from the front side to the rear side of the vehicle, is transmitted to the upper frame reinforcing member 140 via the radiator panel frame 100. Because the upper frame reinforcing member 140 is fixed to the front side frame 110 by the joint members JP, the upper frame reinforcing member 140 is deformed while maintaining the rigidity with the front side frame 110.

The collision energy indicated by arrows SB4 and SB5 is transmitted to the upper frame reinforcing member 140.

The collision energy transmitted to the upper frame reinforcing member 140, indicated by arrow SF, is distributed between and absorbed by the toe board 40 and the strut tower 50, which are joined to the rear side of the upper frame reinforcing member 140, as indicated by arrows SG and SH.

The collision energy indicated by arrow SB5, directed from the front side to the rear side of the vehicle, is transmitted to the radiator panel reinforcing member 150 via the radiator panel frame 100. Then, the collision energy is absorbed by crushing and deformation of the radiator panel reinforcing member 150.

Because the radiator panel reinforcing members 150 are disposed such that the distance therebetween increases from the front side toward the rear side of the vehicle, the collision energy deforms the upper frame reinforcing member 140 toward the outer side in the vehicle width direction, as indicated by arrow SC. This cancels out the rotational deformation in the direction indicated by arrow SB6.

The collision energy indicated by arrow SB5, transmitted to the radiator panel reinforcing member 150, is then transmitted to the upper frame reinforcing member 140 and is distributed and absorbed via the upper frame reinforcing member 140.

Absorption of the collision energy by the deformation of the front part structure S ends with the end of input of the collision energy.

As described above, the collision energy generated by the collision with the object FB2 is absorbed by crushing and deformation of the front part structure S, which includes the radiator panel frame 100, the front side frames 110, the sub frames 120, the front cross member 130, the upper frame reinforcing members 140, and the radiator panel reinforcing members 150, in front of the front cross member 130.

Furthermore, because the front side frame 110 and the upper frame reinforcing member 140 are fixed together by the joint members JP, the front side frame 110 is deformed together with the upper frame reinforcing member 140, while maintaining rigidity. Furthermore, as a result of the projection PP protruding outward at the upper part of the radiator panel frame 100 coming into contact with the upper frame reinforcing member 140 and the radiator panel reinforcing member 150, rotational motion of the radiator panel frame 100 toward the inner side in the vehicle width direction is restricted. Because the radiator panel reinforcing member 150 extends outward in the vehicle width direction, the upper frame reinforcing member 140 is deformed outward.

The collision energy generated by the collision with the object FB2 is distributed in and absorbed by the front chamber FA, which includes the front side frames 110, the front cross member 130, the toe board 40, the strut towers 50, the torque box 60, and the side sills 70.

Hence, the inverter unit 30, which is disposed between, in the vehicle width direction, the front side frames 110, the sub frames 120, and the upper frame reinforcing members 140 extending in the vehicle longitudinal direction on both sides in the vehicle width direction and behind the front cross member 130, is not deformed.

### Under-Ride Collision

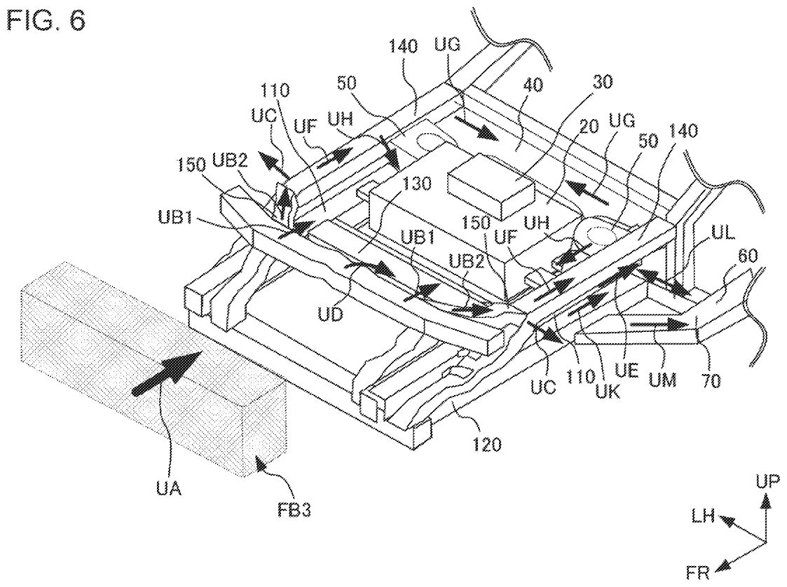

As illustrated in FIG. 6, in an under-ride collision, the object FB3 collides with the upper part of the vehicle V, generating collision energy in the direction of arrow UA.

The collision energy generated by the collision with the object FB3 is transmitted to the rear side of the vehicle via the upper side of the radiator panel frame 100, as indicated by arrow UB1.

The upper side of the radiator panel frame 100 is pushed by the collision energy and moves toward the rear side of the vehicle. Furthermore, the radiator panel frame 100 starts to tilt toward the lower rear side of the vehicle, as indicated by arrow UD, so as to rotate about the lower side member of the radiator panel frame 100.

At this time, the radiator panel reinforcing members 150, which are joined to the upper outer sides of the radiator panel frame 100, are crushed and deformed toward the rear side of the vehicle, while restricting tilting of the radiator panel frame 100.

When the crushing and deformation of the radiator panel reinforcing members 150 progress, the projections PP provided on the upper side of the radiator panel frame 100 come into contact with the upper frame reinforcing members 140 and the radiator panel reinforcing members 150. This restricts deformation of the upper side of the radiator panel frame 100 toward the rear side of the vehicle.

The collision energy indicated by arrows UB2, transmitted to the radiator panel reinforcing members 150, is transmitted to the upper frame reinforcing members 140.

Because the radiator panel reinforcing members 150 are disposed such that the distance therebetween increases from the front side toward the rear side of the vehicle, the collision energy deforms the upper frame reinforcing members 140 toward the outer sides in the vehicle width direction, as indicated by arrows UC.

At this time, because the upper frame reinforcing members 140 are fixed to the front side frames 110 by the joint members JP, the upper frame reinforcing members 140 are deformed while maintaining the rigidity with the front side frames 110.

Then, the collision energy is distributed between the front side frames 110 and the sub frames 120, which are fixed to the upper frame reinforcing members 140.

The collision energy indicated by arrows UF, directed from the front side toward the rear side of the vehicle, is transmitted to the upper frame reinforcing members 140. The upper frame reinforcing members 140 are crushed by the collision energy, and the collision energy is absorbed by the deformation of the upper frame reinforcing members 140.

The collision energy transmitted to the upper frame reinforcing members 140 is distributed between and absorbed by the toe board 40 and the strut towers 50, which are joined to the rear side of the upper frame reinforcing members 140, as indicated by arrows UG and UH.

The collision energy indicated by arrow UE, directed from the front side toward the rear side of the vehicle, is transmitted to the front side frames 110 via the upper frame reinforcing members 140. Then, the collision energy transmitted to the front side frames 110, indicated by arrow UE, is distributed between and absorbed by the toe board 40 and the torque box 60, as indicated by arrows UG and UL.

The collision energy indicated by arrow UK, directed from the front side toward the rear side of the vehicle, is transmitted to the sub frames 120 via the upper frame reinforcing members 140. The collision energy transmitted to the sub frames 120, indicated by arrow UK, is distributed among and absorbed by the toe board 40, the torque box 60, and the side sills 70, as indicated by arrows UG, UL, and UM.

Absorption of the collision energy by the deformation of the front part structure S ends with the end of input of the collision energy.

As described above, the collision energy is absorbed by crushing and deformation of the front part structure S, which includes the radiator panel frame 100, the upper frame reinforcing members 140, and the radiator panel reinforcing members 150. Furthermore, the collision energy is distributed between the front side frames 110 and the sub frames 120, which are fixed to the upper frame reinforcing members 140.

Furthermore, the radiator panel reinforcing members 150 are crushed and deformed toward the rear side of the vehicle, while restricting tilting of the radiator panel frame 100 toward the rear side of the vehicle. Furthermore, the projections PP of the radiator panel frame 100 restrict deformation of the upper side of the radiator panel frame 100 toward the rear side of the vehicle. Because the radiator panel reinforcing members 150 extend outward in the vehicle width direction, the upper frame reinforcing members 140 are deformed outward.

Furthermore, the collision energy is distributed in and absorbed by the front chamber FA, which includes the front side frames 110, the front cross member 130, the toe board 40, the strut towers 50, the torque box 60, and the side sills 70.

Hence, the inverter unit 30, which is disposed between, in the vehicle width direction, the front side frames 110, the sub frames 120, and the upper frame reinforcing members 140 extending in the vehicle longitudinal direction on both sides in the vehicle width direction and behind the front cross member 130, is not deformed.

The front part structure S according to this embodiment is provided in front of a cabin CA for occupants, and includes: the radiator panel frame 100 formed at the front side of the vehicle, in a rectangular shape having long sides extending in the vehicle width direction and short sides extending in the vehicle vertical direction, and having projections PP protruding toward the rear side of the vehicle, on the outer sides, in the vehicle width direction, of the upper side member; a pair of front side frames 110 extending in the vehicle longitudinal direction, on both sides in the vehicle width direction, on the lower side of the vehicle, and joined to the radiator panel frame 100 at the front ends thereof; the sub frames 120 extending in the vehicle longitudinal direction, below and on the outer sides of the front side frames 110 in the vehicle width direction, and joined to the lower outer parts, in the vehicle width direction, of the radiator panel frame 100 at the front ends thereof; a pair of upper frame reinforcing members 140 extending toward the front side of the vehicle from the front side of the cabin, on both sides in the vehicle width direction, on the upper side of the vehicle, bent downward toward the front side of the vehicle to have slope parts TL extending toward the lower front side of the vehicle, and joined to the lower outer parts, in the vehicle width direction, of the radiator panel frame 100 at the lower front ends thereof; the radiator panel reinforcing members 150 whose first ends are joined to the upper side member of the radiator panel frame 100, at positions more inward than the projections PP in the vehicle width direction, and whose second ends are joined to the upper front sides of the slope parts TL of the upper frame reinforcing members 140; and the joint members JP joining the upper frame reinforcing members 140 and the front side frames 110 at the slope parts TL of the upper frame reinforcing members 140.

In a full-overlap collision, the collision energy directed to the rear side of the vehicle is transmitted via the front side frames 110. The collision energy moves the front side frames 110 toward the rear side of the vehicle, breaking the joint members JP fixing the front side frames 110 and the upper frame reinforcing members 140 to each other. Then, the front side frames 110 become free from the influence of the rigidity of the upper frame reinforcing members 140 and are crushed and deformed in front of the front cross member 130. Thus, the front side frames 110 can absorb the collision energy in front of the front cross member 130. Because the radiator panel reinforcing members 150 extend outward in the vehicle width direction, the upper frame reinforcing members 140 are deformed outward. Thus, the front part structure S can restrict deformation toward the inner side in the vehicle width direction.

In a small-overlap collision, the collision energy directed to the inner rear side of the vehicle is transmitted via the front side frame 110 and the radiator panel frame 100 on the collided side. As a result of the upper frame reinforcing member 140 and the radiator panel reinforcing member 150 being deformed and crushed in front of the front cross member 130, the collision energy is absorbed by the upper frame reinforcing member 140 and the radiator panel reinforcing member 150. Furthermore, because the front side frame 110 and the upper frame reinforcing member 140 are fixed together by the joint members JP, the front side frame 110 is deformed together with the upper frame reinforcing member 140, while maintaining rigidity. Furthermore, as a result of the projection PP protruding outward at the upper part of the radiator panel frame 100 coming into contact with the upper frame reinforcing member 140 and the radiator panel reinforcing member 150, rotational motion of the radiator panel frame 100 toward the inner side in the vehicle width direction is restricted. Furthermore, because the radiator panel reinforcing member 150 extends outward in the vehicle width direction, the upper frame reinforcing member 140 is deformed outward. Thus, the front part structure S can restrict deformation toward the inner side in the vehicle width direction.

In an under-ride collision, the collision energy directed to the rear side of the vehicle is transmitted via the upper side of the radiator panel frame 100. The radiator panel reinforcing members 150 are crushed and deformed toward the rear side of the vehicle, while restricting tilting of the radiator panel frame 100 toward the rear side of the vehicle. Furthermore, the projections PP of the radiator panel frame 100 restrict movement of the upper side of the radiator panel frame 100 toward the rear side of the vehicle. Thus, the front part structure S can absorb the collision energy in the radiator panel frame 100 and the radiator panel reinforcing members 150. Furthermore, because the front side frames 110 and the upper frame reinforcing members 140 are fixed together by the joint members JP, the front side frames 110 are deformed together with the upper frame reinforcing members 140, while maintaining rigidity. Thus, the front part structure S can distribute the collision energy among the upper frame reinforcing members 140, the front side frames 110, and the sub frames 120. Because the radiator panel reinforcing members 150 extend outward in the vehicle width direction, the upper frame reinforcing members 140 are deformed outward. Thus, the front part structure S can restrict deformation toward the inner side in the vehicle width direction.

Furthermore, in full-overlap, small-overlap, and under-ride collisions, the collision energy is distributed in and absorbed by the front chamber FA, which includes the front side frames 110, the sub frames 120, the front cross member 130, the upper frame reinforcing members 140, the radiator panel reinforcing members 150, the toe board 40, the strut towers 50, the torque box 60, and the side sills 70.

In other words, in full-overlap, small-overlap, and under-ride collisions, the collision energy is distributed and absorbed by crushing, deformation toward the outer sides in the vehicle width direction, restriction of moving direction, and reaction forces of the radiator panel frame 100, the front side frames 110, the sub frame 120, the upper frame reinforcing members 140, and the radiator panel reinforcing members 150. Thus, it is possible to absorb the collision energy without deforming the inverter unit 30, which is disposed on the inner side of the front part structure S in the vehicle width direction and behind the front cross member 130.

Hence, it is possible to prevent deformation of the inverter unit 30 in multiple types of frontal collisions.

In the front part structure S according to this embodiment, the joint members JP are L-shaped plates bent so as to extend forward in the vehicle longitudinal direction and outward in the vehicle width direction.

In a full-overlap collision, the collision energy moves the front side frames 110 from the front side toward the rear side of the vehicle, shifting the relative positions of the front side frames 110 and the upper frame reinforcing members 140. The joint members JP are broken at the L-shaped bent portions, and the front side frames 110 and the upper frame reinforcing members 140 are separated. The front side frames 110 become free from the influence of the rigidity of the upper frame reinforcing members 140.

Hence, in a full-overlap collision, the front part structure S absorbs the collision energy by allowing the front side frames 110 to be crushed and deformed in front of the front cross member 130.

In a small-overlap collision, the collision energy generates rotational motion of the front side frame 110 toward the inner side in the vehicle width direction with the reaction force generated in the front cross member 130 joined to the front side frame 110, directed toward the inner side in the vehicle width direction.

At this time, because the front side frame 110 moves toward the inner side in the vehicle width direction, the joint members JP keep the front side frame 110 and the upper frame reinforcing member 140 fixed to each other without being broken. The upper frame reinforcing member 140 restricts the rotational motion of the front side frame 110 via the joint members JP.

Hence, in a small-overlap collision, the front part structure S absorbs the collision energy by allowing the front side frame 110 and the upper frame reinforcing member 140 to be deformed while being fixed to each other and maintaining rigidity.

In an under-ride collision, the collision energy is transmitted to the front side frames 110 via the upper frame reinforcing members 140. The front side frames 110 and the upper frame reinforcing members 140 are fixed to each other by the joint members JP.

Hence, in the under-ride collision, the front part structure S absorbs the collision energy by allowing the front side frames 110 and the upper frame reinforcing members 140 to be deformed while being fixed to each other and maintaining rigidity.

Hence, it is possible to prevent deformation of the inverter unit 30 in multiple types of frontal collisions.

In the front part structure S according to this embodiment, the joint members JP are fixed to the upper ridges and the lower ridges of the outer surfaces of the front side frames 110 in the vehicle width direction, at positions where the upper frame reinforcing members 140 and the front side frames 110 cross each other.

In a full-overlap collision, the joint members JP1 and JP2 appropriately follow the deformation of the upper ridges and the lower ridges of the front side frames 110 toward the rear side of the vehicle, and are deformed or broken. As a result, the front side frames 110 become free from the influence of the rigidity of the upper frame reinforcing members 140.

Hence, in a full-overlap collision, the front part structure S absorbs the collision energy by allowing the front side frames 110 to be crushed and deformed in front of the front cross member 130.

Meanwhile, in a small-overlap collision, the upper ridge and the lower ridge of the front side frame 110 and the upper frame reinforcing member 140 deform toward the inner side in the vehicle width direction. The front side frame 110 and the upper frame reinforcing member 140 are fixed to each other with the joint members JP1 and JP2.

In an under-ride collision, the collision energy is transmitted via the upper frame reinforcing members 140 without deforming the upper ridges and the lower ridges of the front side frames 110. The front side frames 110 and the upper frame reinforcing members 140 are fixed to each other with the joint members JP1 and JP2.

Thus, in small-overlap and under-ride collisions, the front part structure S absorbs the collision energy by allowing the front side frames 110 to maintain the rigidity in front of the front cross member 130.

In other words, because the joint members JP1 and JP2 are fixed to the upper ridges and the lower ridges of the front side frames 110, the joint members JP1 and JP2 appropriately follow the deformation of the front side frames 110 and are deformed. Thus, the front part structure S can absorb the collision energy in multiple types of frontal collisions.

Hence, it is possible to prevent deformation of the inverter unit 30 in multiple types of frontal collisions.

Note that the ends of the front part structure S in the vehicle longitudinal direction and the vehicle width direction may be closed by metal or the like.

The joint members JP may be replaced with fixation by welding or the like.

Although the embodiment of the disclosure has been described in detail above with reference to the drawings, the structure of the disclosure is not limited to one described above, and designs and the like within a scope not departing from the gist of the disclosure are also included.

1. A vehicle body front part structure provided in a front portion of a vehicle in a vehicle longitudinal direction of the vehicle, the front portion being provided in front of a cabin configured to accommodate one or more occupants of the vehicle, the vehicle body front part structure comprising:
a radiator panel frame provided in the front portion, the radiator panel frame having a rectangular shape having long sides extending in a vehicle width direction of the vehicle and short sides extending in a vehicle vertical direction of the vehicle, and comprising projections on outer sides of an upper side member in the vehicle width direction, the projections protruding toward a rear side of the vehicle;
front side frames in a pair, the front side frames being disposed respectively on both sides in the vehicle width direction on a lower side of the vehicle, extending in the vehicle longitudinal direction of the vehicle, and having front ends joined to the radiator panel frame in the front portion;
sub frames disposed below and on outer sides of the front side frames in the vehicle width direction, extending in the vehicle longitudinal direction, and having front ends on the front side of the vehicle joined to lower outer parts of the radiator panel frame in the vehicle width direction;
upper frame reinforcing members in a pair, the upper frame reinforcing members being disposed respectively on both sides in the vehicle width direction on an upper side of the vehicle, extending forward from the front portion, being bent downward toward the front side of the vehicle to have slope parts extending toward a lower front side of the vehicle in the front portion, and having lower front ends on the lower side of the vehicle joined to respective lower outer parts of the radiator panel frame in the vehicle width direction;
radiator panel reinforcing members each having a first end joined to the upper side member of the radiator panel frame at a position more inward than a corresponding one of the projection in the vehicle width direction, and a second end joined to an upper front side of a corresponding one of the slope parts; and
joint members each joining a corresponding one of the upper frame reinforcing members and a corresponding one of the front side frames at a corresponding one of the slope parts.

2. The vehicle body front part structure according to claim 1, wherein the joint members are L-shaped plates bent so as to extend forward in the vehicle longitudinal direction and outward in the vehicle width direction.

3. The vehicle body front part structure according to claim 2, wherein the joint members are each fixed to an upper ridge and a lower ridge of an outer surface of a corresponding one of the front side frames in the vehicle width direction, at a position where a corresponding one of the upper frame reinforcing members and the corresponding one of the front side frames cross each other.
